(19) United States
(12) Patent Application Publication
(10) Pub. No.: US 2026/0343468 A1
(43) Pub. Date: Oct. 29, 2026

(54) HANDLING COMMUNICATION DEVICE ASSOCIATED POSITIONING SIGNALING VIA LOCAL ACCESS AND MOBILITY MANAGEMENT FUNCTION

(71) Applicant: Telefonaktiebolaget LM Ericsson (publ), Stockholm (SE)

(72) Inventors: Mohammed Yazid LYAZIDI, London (GB); Nianshan SHI, JÄRFÄLLA (SE); Richárd BÁTORFI, Budapest (HU)

(73) Assignee: Telefonaktiebolaget LM Ericsson (publ), Stockholm (SE)

(21) Appl. No.: 19/110,904

(22) PCT Filed: Sep. 20, 2023
(86) PCT No.: PCT/SE2023/050925

§ 371 Date: Mar. 12, 2025

Related U.S. Application Data
(60) Provisional application No. 63/408,694, filed on Sep. 21, 2022.

(51) Int. Cl. H04W 64/00

(52) U.S. Cl. CPC H04W 64/00

(57) ABSTRACT

A first node configured to provide a location management function (“LMF”) can transmit a first message to a second node. The second node can be configured to provide a serving access and mobility management function (“AMF”). The first message can indicate that a third node transmit positioning information to the LMF via a fourth node configured to provide a local AMF. Subsequent to transmitting the first message, the first node can receive the positioning information from the third node via the local AMF.

### TECHNICAL FIELD

The present disclosure is related to wireless communication systems and more particularly to handling communication device associated positioning signaling via local access and mobility management function.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

In the 3^{rd} Generation Partnership Project (“3GPP”) Release 18 (“Rel-18”) “eLCS_ph3” study, System Aspects 2 (“SA2”) has discussed enhanced positioning architecture for non-public network (“NPN”) deployment. For NPN deployments, a local access and mobility management function (“AMF”) (or any AMF) can be used to transfer non-UE associated network assistance data between a radio access network (“RAN”) and location management function (“LMF”). For UE associated network positioning, the LMF can send a UE associated network positioning message toward the RAN via the serving AMF. The LMF can notify the UE location to the gateway mobile location center (“GMLC”) directly (e.g., without going through the serving AMF).

FIG. 2 illustrates an example of a public network 210 communicatively coupled to a NPN 250. The public network 210 includes an AMF module 212 and a unified data management (“UDM”) module 214. The NPN 250 includes a UE 252, next-generation radio access network (“NG-RAN”) nodes 254a-c, a LMF module 256, a GMLC 258, a location services (“LCS”) client 270, and an AMF module 260. The AMF module 212 can be used for general service operations and the local AMF/any AMF module 260 can be used for LCS operation. The UE location result can be transmitted directly form the LMF module 256 to the GMLC 258. The non-UE NR Positioning Protocol A (“NRPPa”) messages can be transmitted between the LMF module 256 and the local AMF/any AMF 260. The UE associated NRPPa requested message can be transmitted via the AMF 212.

FIG. 3 illustrates an example of a UE associated NRPPa Request message. The message can be sent by the AMF 212 and can be used for carrying the NRPPa message over the NG interface. The Routing Identifier (“ID”) can correspond to the LMF identifier, while the NRPPa-PDU can include the LMF-NG-RAN node message that is transferred without interpretation in the AMF 212.

The local AMF 260 can be defined as a “Positioning Function AMF” or “local AMF for positioning function only”. The interface between local AMF 260 and LMF module 256 can be NL1. The local AMF 260 may not retain state information for Network Assisted Positioning procedure and Non-UE Associated Network Assistance Data procedure (e.g., any response from NG-RAN can be treated as a separate non-associated transfer).

The Local AMF 260 can support the management of a N2 interface (e.g., the TNL association between the RAN nodes 254a-c and the Local AMF 260). The TNL association between the RAN nodes 254a-c and the local AMF 260 can be pre-established via configuration. The weight factor of TNL association with the Local AMF 260 can be set to zero so that the RAN nodes 254a-c may not select the Local AMF 260 for initial N2.

### SUMMARY

According to some embodiments, a method of operating a first node configured to provide a location management function (“LMF”) is provided. The method includes transmitting a first message to a second node. The second node is configured to provide a serving access and mobility management function (“AMF”). The first message indicates that a third node transmit positioning information to the LMF via a fourth node configured to provide a local AMF. The method further includes, subsequent to transmitting the first message, receiving the positioning information from the third node via the local AMF.

According to other embodiments, a method of operating a second node configured to provide a serving access and mobility management function (“AMF”) is provided. The method includes receiving a first message from a first node configured to provide a location management function (“LMF”). The first message indicates that a third node transmit positioning information to the LMF via a fourth node configured to provide a local AMF. The method further includes, responsive to receiving the first message, transmitting a second message to the third node instructing the third node to transmit positioning information to the LMF via the local AMF.

According to other embodiments, a method of operating a third node is provided.

The method includes receiving a first message from a second node that is configured to provide a serving access and mobility management function (“AMF”). The first message indicates that the third node transmit positioning information to a first node that is configured to provide a location management function (“LMF”) via a fourth node configured to provide a local AMF. The method further includes, subsequent to receiving the first message, transmitting a second message to the LMF via the local AMF. The second message includes the positioning information.

According to other embodiments, a network node, a LMF, a serving AMF, a computer program, a computer program product, a non-transitory computer-readable medium, a host, or a system is provided to perform one of the above methods.

Certain embodiments may provide one or more of the following technical advantages. In some embodiments, routing from NG-RAN node to LMF via local AMF can cause NG-AP latency reduction.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of a public network communicatively coupled to a non-public network (“NPN”);

FIG. 3 is a table illustrating an example of a user equipment (“UE”) associated new radio Positioning Protocol A (“NRPPa”) Request message;

FIG. 4 is a table illustrating an example of a downlink (“DL”) UE associated NRPPa transport message in accordance with some embodiments;

FIG. 5 is a table illustrating an example of an uplink (“UL”) non-UE associated NRPPa transport message in accordance with some embodiments;

FIG. 6 is a table illustrating an example of a UL NRPPa transport message in accordance with some embodiments;

FIGS. 7-9 are flow charts illustrating examples of operations performed by a network node in accordance with some embodiments;

FIG. 10 is a block diagram of a communication system in accordance with some embodiments;

FIG. 11 is a block diagram of a user equipment in accordance with some embodiments;

FIG. 12 is a block diagram of a network node in accordance with some embodiments;

FIG. 13 is a block diagram of a host computer communicating with a user equipment in accordance with some embodiments;

FIG. 14 is a block diagram of a virtualization environment in accordance with some embodiments; and

FIG. 15 is a block diagram of a host computer communicating via a base station with a user equipment over a partially wireless connection in accordance with some embodiments.

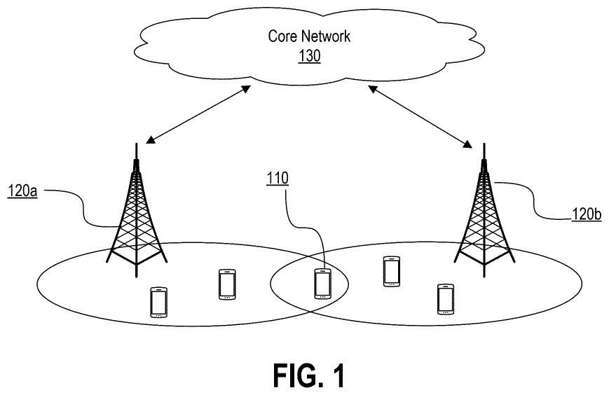

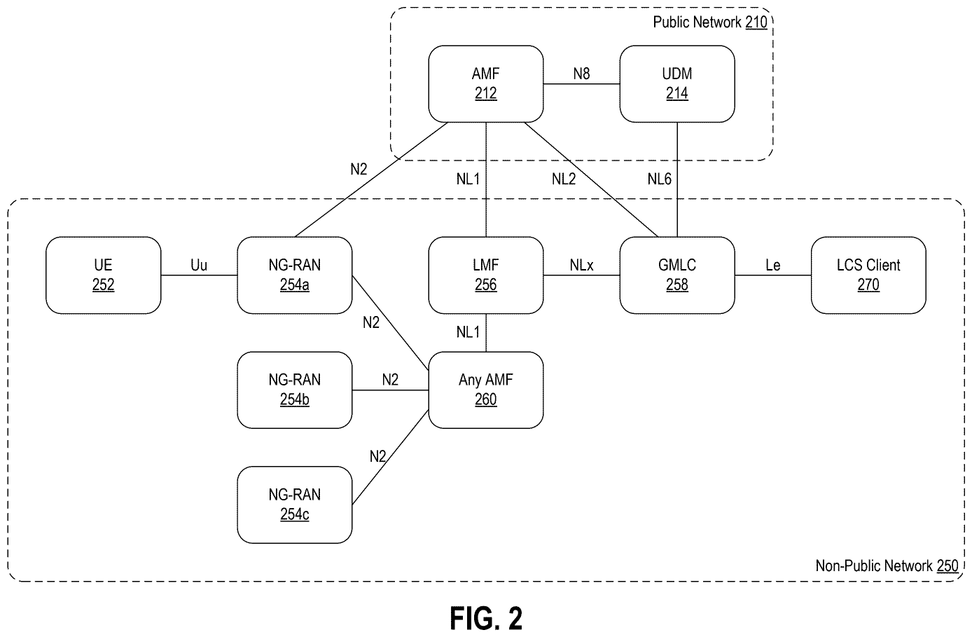

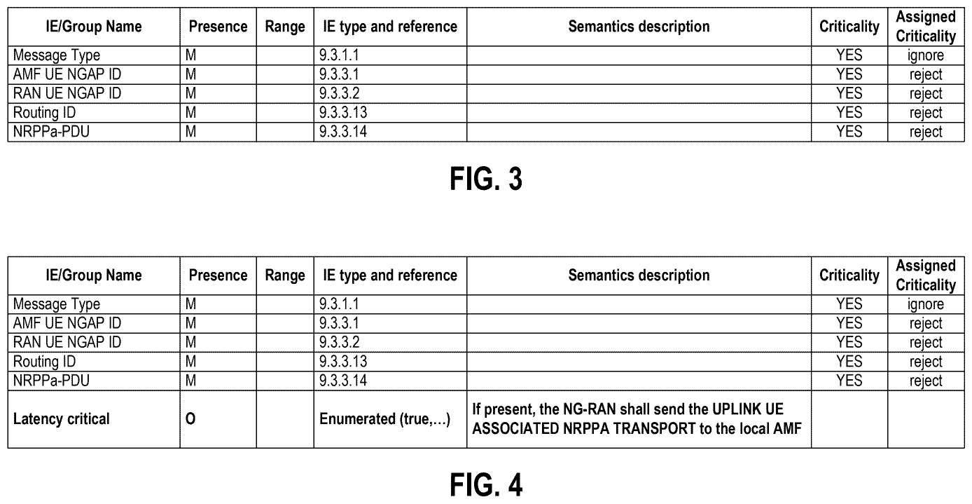

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

One open issue is the process for UE associated NRPPa Response message transmission. In some examples, the UE associated NRPPa Response message is transmitted via an AMF in a public network. In this example, the latency is the same as the traditional network with no new impact.

In other examples, a UE associated NRPPa Response message is transmitted via a local AMF. In this example, the latency is reduced relative to a traditional network, the impacts are on local AMF and RAN.

Transmitting the UE associated NRPPa Response message via the local AMF relies on the local AMF performing the routing between the NG-RAN node that received the UE associated NRPPa Requested message from the AMF in the public domain with the LMF, so that the latency reduction is achieved. As described above, the NG-RAN node knows the local AMF(s) connected to it via pre-configuration and the local AMF is used only for non UE associated positioning, while all other functionalities related to the UE reside in the public network AMF. Therefore, this process cannot be supported as such without some enhancement to the current NG Application Protocol (“NGAP”) signaling.

Certain aspects of the disclosure and their embodiments may provide solutions to these or other challenges. In some embodiments, operations are provided for handling communication device associated positioning signaling via local access and mobility management function. In some examples, the operations include signaling from LMF to the serving AMF to NG-RAN node, an indication that the positioning UE associated and non-UE associated information by the NG-RAN node must be encapsulated and signaled from the NG-RAN node to Local AMF and back to LMF.

In additional or alternative examples, the operations include indicating a new “local AMF ID” in the NRPPA UE associated downlink (“DL”) request message so that NG-RAN knows the ID of the local LMF it should send back the uplink (“UL”) message.

In additional or alternative examples, the operations include defining a new NG-AP message/procedure that can signal UL UE associated NRPPa message to be transported as non UE associated message via the local AMF, i.e. the UE associated NRPPa message is wrapped in a container and carried in the non-UE associated message.

In additional or alternative examples, the operations include the NG-RAN node delivering the non-UE associated NRPPa message to the local AMF, when it is instructed.

Some embodiments describe signaling a request from LMF via serving AMF to NG-RAN to the UL NRPPa UE associated response message corresponding to the DL UE associated received request message should be signaled back to LMF via the local AMF.

Additional or alternative embodiments describe ssignaling a request from LMF via serving AMF to NG-RAN to the UL NRPPAa non UE associated response message corresponding to the DL non UE associated received request message should be signaled back to LMF via the local AMF.

Additional or alternative embodiments describe a new NG-AP message for transport of positioning only information via local AMF.

In some embodiments, a serving access and mobility management function (“AMF”) signals to a next generation radio access network (“NG-RAN”) node that the positioning related information for a communication device (also referred to herein as a user equipment (“UE”)) is preconfigured or appointed to a local AMF, for example, via an Initial Context Setup procedure or positioning related procedures.

In additional or alternative embodiments, the serving AMF signals to a NG-RAN node that the positioning related information for a group of UEs or a group of measurement identifiers (“IDs”) is preconfigured or appointed to a local AMF, for example, via an Initial Context Setup procedure or positioning related procedures.

In additional or alternative embodiments, an indication is added in a downlink (“DL”) UE associated new radio positioning protocol A (“NRPPa”) transport message in a next generation application protocol (“NG-AP”) to indicate that the NG-RAN node will signal the uplink (“UL”) UE associated response message to a location management function (“LMF”) via the Local AMF. In some examples, the indication is related to latency reduction purpose. If present the NG-RAN can send the UL UE associated NRPPA response using the configured local AMF.

FIG. 4 illustrates an example of a DL UE associated NRPPa transport message. The message is sent by the AMF and is used for carrying a NRPPa message over the NG interface.

If the private network has pre-configured the NG-RAN with a local AMF, the NG-RAN can signal an UL UE associated NRPPa transport message to the local AMF. Since the local AMF only supports non-associated transfer form NG-RAN, the UL UE associated NRPPa transport message can be encapsulated in a non-associated message to the local AMF.

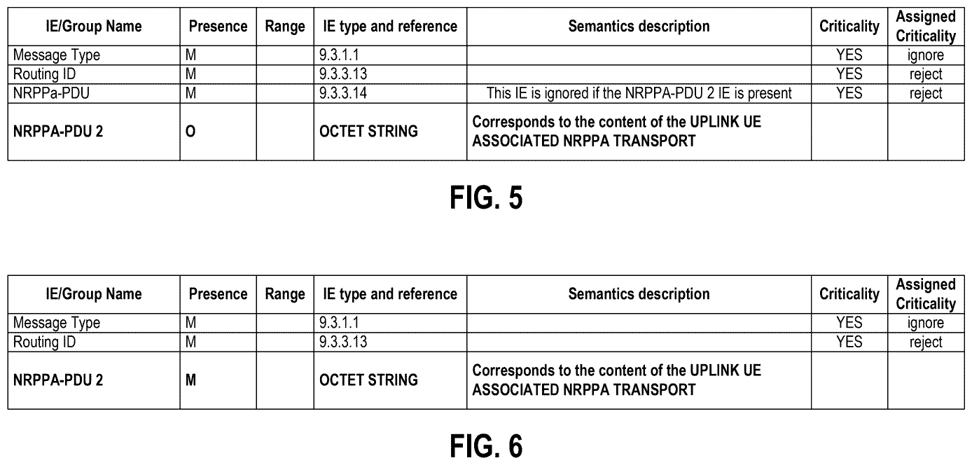

In additional or alternative embodiments, the encapsulation of the UL UE association response message can be realized by enhancing existing NG-AP message UL non-UE associated NRPPa transport. FIG. 5 illustrates an example of an UL non-UE associated NRPPa transport message. The message can be sent by the NG-RAN node and can be used for carrying a NRPPa message over the NG interface.

In additional or alternative embodiments, the UL response to local AMF can be achieved via a new message. FIG. 6 illustrates an example of an UL NRPPa transport message. This message can be sent by the NG-RAN node and can be used for carrying a NRPPa message over the NG interface to the local AMF.

In some examples, the local AMF routes the received UL non UE associated NRPPA message to the LMF.

In additional or alternative examples, the LMF, upon receiving the message from local AMF with the encapsulated UE related associated information, signals, if needed, a DL UE associated request message to NG-RAN via the serving AMF in the public domain using the AMF UE NGAP ID extracted from the encapsulated message.

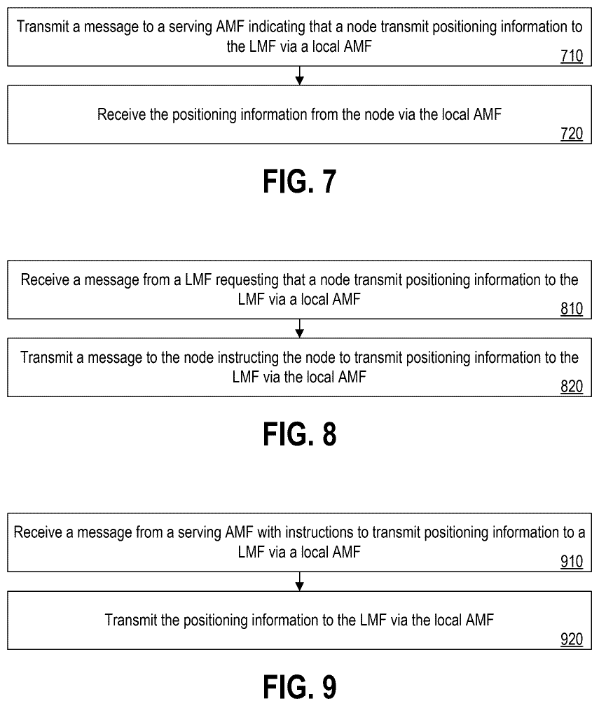

In the description that follows, while a node may be any of a LMF module 256, an AMF 212, one of NG-RAN 254a-c, network node 1010A-B, HUB 1014, Core network node 1008, network node 1200, virtualization hardware 1404, virtual machines 1408A, 1408B, or network node 1504, the network node 1200 shall be used to describe the functionality of the operations of the node. Operations of the node 1200 (implemented using the structure of the block diagram of FIG. 12) will now be discussed with reference to the flow chart of FIGS. 7-9 according to some embodiments of inventive concepts. For example, modules may be stored in memory 1204 of FIG. 12, and these modules may provide instructions so that when the instructions of a module are executed by respective network node processing circuitry 1202, processing circuitry 1202 performs respective operations of the flow charts.

FIG. 7 illustrates an example of operations performed by a first node (e.g., network node 1100) configured to provide a LMF (e.g., LMF 256).

At block 710, processing circuitry 1102 transmits, via communication interface 1206, a message to a serving AMF (e.g., serving AMF 212) indicating that a node (e.g., NG-RAN node 254a) transmit positioning information to the LMF via a local AMF (e.g., AMF 260).

In some embodiments, transmitting the first message comprises transmitting instructions that the serving AMF transmit a DL UE associated NRPPa, transport message (e.g., as illustrated in FIG. 4) to the node. In some examples, the DL UE associated NRPPa transport message includes an indication that the node transmit the positioning information to the LMF via the local AMF, an indication of the AMF, and/or that latency is critical.

In additional or alternative embodiments, the node is communicatively coupled to a communication device and the positioning information is positioning information associated with the communication device. The first message can further indicate that the node encapsulate the positioning information associated with the communication device within a non-associated message. In some examples, the non-associated message includes an UL non-UE associated NRPPa transport message (e.g., as illustrated in FIG. 5).

In additional or alternative embodiments, the positioning information includes at least one of: positioning information associated with a single communication device; and positioning information associated with a group of communication devices.

At block 720, processing circuitry 1102 receives, via communication interface 1206, the positioning information from the node via the local AMF.

In some embodiments, receiving the positioning information includes receiving a non-associated message and extracting the positioning information from the non-associated message.

FIG. 8 illustrates an example of operations performed by a second node (e.g., network node 1100) configured to provide a serving AMF (e.g., serving AMF 212).

At block 810, processing circuitry 1102 receives, via communication interface 1206, a message from a LMF (e.g., LMF 256) indicating that a node (e.g., NG-RAN node 254a) transmit positioning information to the LMF via a local AMF (e.g., AMF 260).

At block 820, processing circuitry 1102 transmits, via communication interface 1206, a message to the node instructing the node to transmit the positioning information to the LMF via the local AMF.

In some embodiments, transmitting the second message includes transmitting a DL UE associated NRPPa transport message (e.g., as illustrated in FIG. 4) to the node. In some examples, the DL UE associated NRPPa transport message includes an indication that the node transmit the positioning information to the LMF via the local AMF, an indication of the AMF, and/or that latency is critical.

In additional or alternative embodiments, the node is communicatively coupled to a communication device and the positioning information is positioning information associated with the communication device. The second message can further indicate that the node encapsulate the positioning information associated with the communication device within a non-associated message. In some examples, the non-associated message includes an UL non-UE associated NRPPa transport message (e.g., as illustrated in FIG. 5).

In additional or alternative embodiments, the positioning information includes at least one of: positioning information associated with a single communication device; and positioning information associated with a group of communication devices.

FIG. 9 illustrates an example of operations performed by a third node (e.g., network node 1100).

At block 910, processing circuitry 1102 receives, via communication interface 1206, a message from a serving AMF (e.g., AMF 212) indicating that the third node (e.g., NG-RAN node 254a) transmit positioning information to the LMF via a local AMF (e.g., AMF 260).

In some embodiments, receiving the first message includes receiving a DL UE associated NRPPa transport message (e.g., as illustrated in FIG. 4) to the node. In some examples, the DL UE associated NRPPa transport message includes an indication that the third node transmit the positioning information to the LMF via the local AMF, an indication of the AMF, and/or that latency is critical.

In additional or alternative embodiments, the third node is communicatively coupled to a communication device and the positioning information is positioning information associated with the communication device. The first message can further indicate that the node encapsulate the positioning information associated with the communication device within a non-associated message. In some examples, the non-associated message includes an UL non-UE associated NRPPa transport message (e.g., as illustrated in FIG. 5).

In additional or alternative embodiments, the positioning information includes at least one of: positioning information associated with a single communication device; and positioning information associated with a group of communication devices.

At block 920, processing circuitry 1102 transmits, via communication interface 1206, the positioning information to the LMF via the local AMF. In some embodiments, transmitting the second message includes transmitting the positioning information encapsulated within a non-associated message. In some examples, the non-associated message includes an UL non-UE associated NRPPa transport message (e.g., as illustrated in FIG. 5).

In some embodiments, in FIGS. 7-9, the LMF is part of a NPN, the serving AMF is part of a public network, the node is a NG-RAN, node that is part of the NPN, and the local AMF is part of the NPN.

Various operations illustrated in FIGS. 7-9 may be optional in respect to some embodiments.

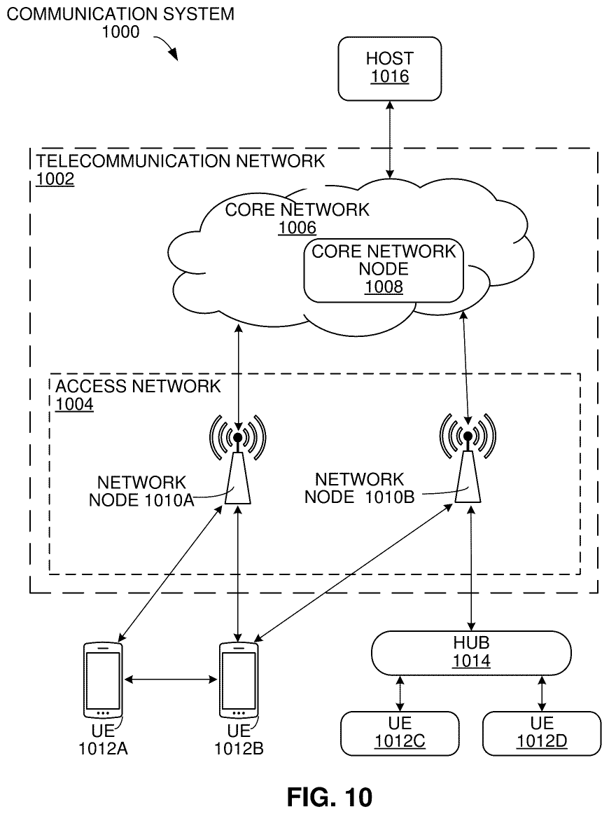

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. Moreover, as will be appreciated by those of skill in the art, the network nodes 1010 are not necessarily limited to an implementation in which a radio portion and a baseband portion are supplied and integrated by a single vendor. Thus, it will be understood that the network nodes 1010 may include disaggregated implementations or portions thereof. For example, in some embodiments, the telecommunication network 1002 includes one or more Open-RAN (ORAN) network nodes. An ORAN network node is a node in the telecommunication network 1002 that supports an ORAN specification (e.g., a specification published by the O-RAN Alliance, or any similar organization) and may operate alone or together with other nodes to implement one or more functionalities of any node in the telecommunication network 1002, including one or more network nodes 1010 and/or core network nodes 1008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1010 facilitate direct or indirect connection of user equipment (UE), such as by connecting wireless devices 1012a, 1012b, 1012c, and 1012d (one or more of which may be generally referred to as UEs 1012) to the core network 1006 over one or more wireless connections. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

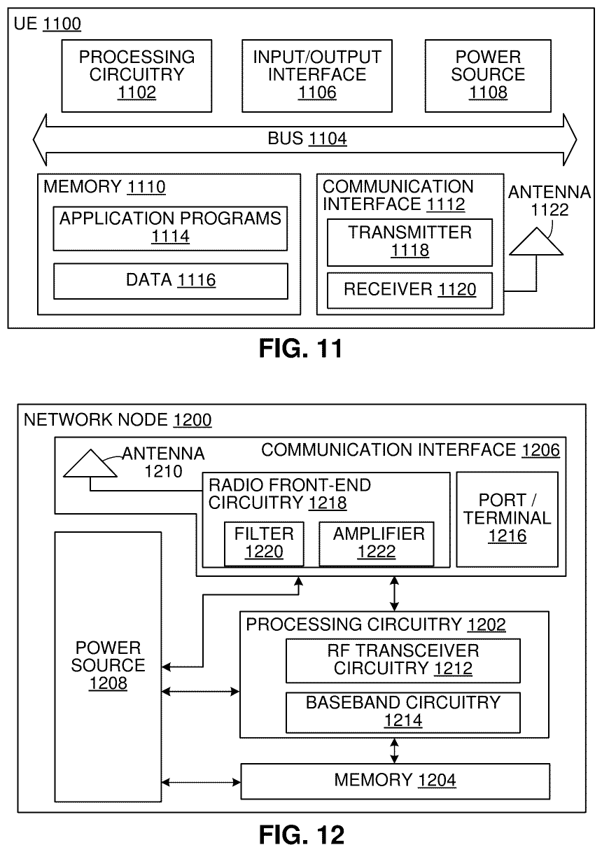

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

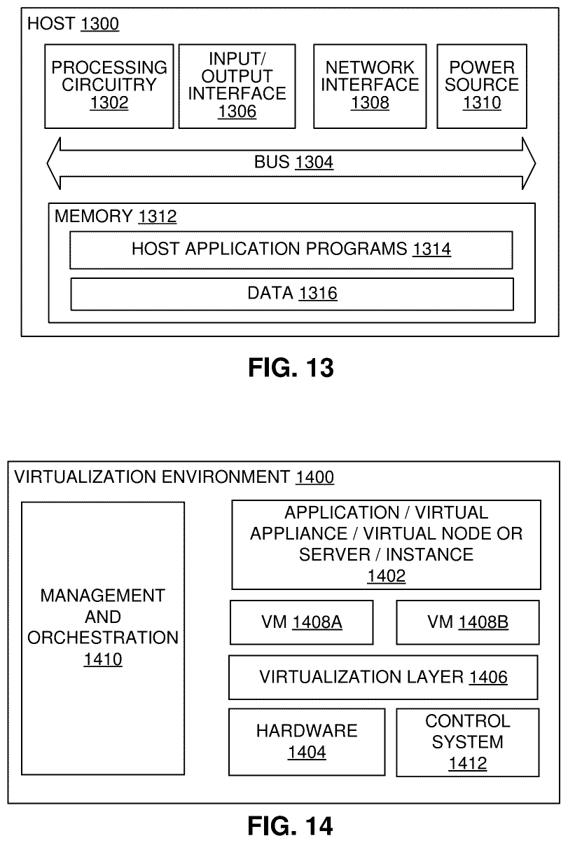

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1400 includes components defined by the O-RAN Alliance, such as an O-Cloud environment orchestrated by a Service Management and Orchestration Framework via an O-2 interface.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

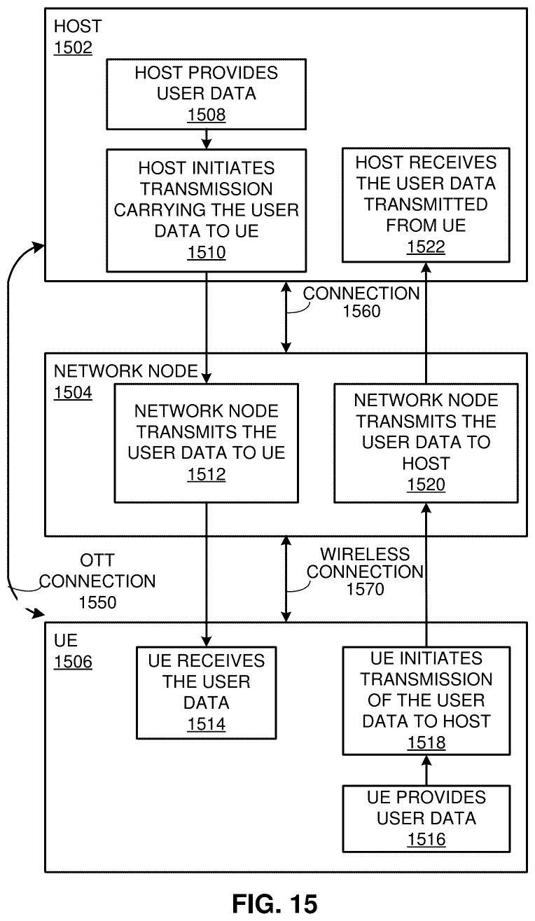

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may reduce NG-AP latency by routing positioning information from NG-RAN node to the LMF via a local AMF rather than the serving AMF.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a first node configured to provide a location management function, LMF, the method comprising:
transmitting a first message to a second node configured to provide a serving access and mobility management function, AMF, the first message indicating that a third node transmit positioning information to the LMF via a fourth node configured to provide a local AMF; and
subsequent to transmitting the first message, receiving the positioning information from the third node via the local AMF.

2. The method of claim 1, wherein transmitting the first message comprises transmitting instructions that the serving AMF transmit a downlink, DL, user equipment, UE, associated new radio Positioning Protocol a, NRPPa, transport message to the third node, wherein the DL UE associated NRPPa transport message includes an indication that the third node transmit the positioning information to the LMF via the local AMF.

3-4. (canceled)

5. The method of claim 1, wherein the LMF is part of a non-public network, NPN,
wherein the serving AMF is part of a public network,
wherein the third node comprises a next generation radio access network, NG-RAN, node that is part of the NPN, and
wherein the local AMF is part of the NPN.

6. The method of claim 1, wherein the third node is communicatively coupled to a communication device, and
wherein the positioning information is positioning information associated with the communication device, wherein the first message further indicates that the third node encapsulate the positioning information associated with the communication device within a non-associated message, wherein the non-associated message comprises an uplink, UL, non-user equipment, UE, associated new radio Positioning Protocol a, NRPPa, transport message.

7-8. (canceled)

9. The method of claim 6, wherein receiving the positioning information comprises:
receiving the non-associated message; and
extracting the positioning information from the non-associated message.

10. The method of claim 1, wherein the positioning information comprises at least one of:
positioning information associated with a single communication device; and
positioning information associated with a group of communication devices.

11. A method of operating a second node configured to provide a serving access and mobility management function, AMF, the method comprising:
receiving a first message from a first node configured to provide a location management function, LMF, the first message indicating that a third node transmit positioning information to the LMF via a fourth node configured to provide a local AMF; and
responsive to receiving the first message, transmitting a second message to the third node instructing the third node to transmit positioning information to the LMF via the local AMF.

12. The method of claim 11, wherein transmitting the second message comprises transmitting a downlink, DL, user equipment, UE, associated new radio Positioning Protocol a, NRPPa, transport message to the third node.

13. The method of claim 12, wherein the DL UE associated NRPPa transport message includes an indication that the third node transmit the positioning information to the LMF via the local AMF.

14. The method of claim 11, wherein the second message includes an indication of an identifier, ID, of the local AMF.

15. The method of claim 11, wherein the LMF is part of a non-public network, NPN, wherein the serving AMF is part of a public network,
wherein the third node comprises a next generation radio access network, NG-RAN, node that is part of the NPN, and
wherein the local AMF is part of the NPN.

16. The method of claim 11, wherein the third node is communicatively coupled to a communication device, and
wherein the positioning information is positioning information associated with the communication device, wherein the second message further indicates that the third node encapsulate the positioning information associated with the communication device within a non-associated message, wherein the non-associated message comprises an uplink, UL, non-user equipment, UE, associated new radio Positioning Protocol a, NRPPa, transport message.

17-18. (canceled)

19. The method of claim 11, wherein the positioning information comprises at least one of:
positioning information associated with a single communication device; and
positioning information associated with a group of communication devices.

20. (canceled)

21. A method of operating a third node, the method comprising:
receiving a first message from a second node configured to provide a serving access and mobility management function, AMF, the first message indicating that the third node transmit positioning information to a first node configured to provide a location management function, LMF, via a fourth node configured to provide a local AMF; and
subsequent to receiving the first message, transmitting a second message to the LMF via the local AMF, the second message including the positioning information.

22-24. (canceled)

25. The method of claim 21, wherein the LMF is part of a non-public network, NPN,
wherein the serving AMF is part of a public network,
wherein the third node comprises a next generation radio access network, NG-RAN, node that is part of the NPN, and
wherein the local AMF is part of the NPN.

26. The method of claim 21, wherein the third node is communicatively coupled to a communication device, and
wherein the positioning information is positioning information associated with the communication device, wherein the first message further indicates that the third node encapsulate the positioning information associated with the communication device within a non-associated message, and
wherein transmitting the second message comprises transmitting the positioning information encapsulated within the non-associated message, wherein the non-associated message comprises an uplink, UL, non-user equipment, UE, associated new radio Positioning Protocol a, NRPPa, transport message.

27-28. (canceled)

29. The method of claim 21, wherein the positioning information comprises at least one of:
positioning information associated with a single communication device; and
positioning information associated with a group of communication devices.

30. The method of claim 21, wherein receiving the first message further comprises receiving an indication that latency is critical.

31. A node the node comprising:
processing circuitry and
memory coupled to the processing circuitry and having instructions stored therein that are executable by the processing circuitry to cause the node to perform operations comprising any of the operations of claim 1.

32-33. (canceled)

34. A non-transitory computer-readable medium having instructions stored therein that are executable by processing circuitry of a node, to cause the node to perform operations comprising any of the operations of claim 1.
